(19) United States
(12) Patent Application Publication
(10) Pub. No.: US 2020/0238560 A1
(43) Pub. Date: Jul. 30, 2020

(54) ROTARY DIES

(71) Applicant: TOYOTA JIDOSHA KABUSHIKI KAISHA, Toyota-shi (JP)

(72) Inventors: Hiromichi NAKATA, Toyota-shi (JP); Noboru SHIMAMOTO, Toyota-shi (JP); Takuya SUKEDA, Toyota-shi (JP); Akinori TOMIOKA, Nagoya-shi (JP); Naoki HIRAI, Miyoshi-shi (JP)

(21) Appl. No.: 16/743,111

(22) Filed: Jan. 15, 2020

(30) Foreign Application Priority Data
Jan. 25, 2019 (JP) 2019-010885
Dec. 10, 2019 (JP) 2019-223171

(51) Int. Cl. B26F 1/38; B26D 1/157; B26D 1/22; B26F 1/44; B26F 1/42

(52) U.S. Cl. CPC B26F 1/384; B26D 1/1575; B26F 1/42; B26F 1/44; B26D 1/225

(57) ABSTRACT

Provided are rotary dies that can cut amorphous materials while having suppressed wear. The rotary dies are adapted to cut a target, and include an anvil roller, a die cutter, a first elastic portion, and a second elastic portion. The anvil roller rotates while supporting the target. The die cutter has a projecting edge for cutting the target and is configured to rotate. The first elastic portion is arranged on the outer peripheral surface of the anvil roller, and elastically deforms upon contacting the rear surface of the target when the target is cut. The second elastic portion is arranged on the outer peripheral surface of the die cutter, and elastically deforms upon contacting the front surface of the target when the target is cut. The hardness of the first elastic portion is greater than that of the second elastic portion.

### CROSS REFERENCE TO RELATED APPLICATIONS

The present application claims priority from Japanese patent application JP 2019-010885 filed on Jan. 25, 2019 and Japanese patent application JP 2019-223171 filed on Dec. 10, 2019, the content of which is hereby incorporated by reference into this application.

### BACKGROUND

### Technical Field

The present disclosure relates to rotary dies for use in rotary die-cutting of amorphous materials.

### Background Art

Conventionally, there is known an invention related to a magnetic core obtained by laminating thin Fe-based nanocrystalline alloy strips, which can be suitably used as a magnetic core of a motor, as well as a production method therefor (see WO 2017/006868 A). The method of producing such a conventional laminated magnetic core includes a shape-giving step of giving desired shapes to thin amorphous strips, a heat treatment step of subjecting the thin amorphous strips with the desired shapes to heat treatment, and laminating the heat-treated thin amorphous strips (see claims 1 and 2 of WO 2017/006868 A).

Meanwhile, there is known an invention related to a rotary cutter adapted to shear a very thin metal member, such as a thin metal plate or a metal foil, into a predetermined shape (see JP 6037690 B). Such a conventional rotary cutter includes a first rotating member, a second rotating member, and elastic bodies (see claim 1 of JP 6037690 B). The first rotating member has at least one of a projection or a recess on its surface. The second rotating member can rotate in the direction opposite to the first rotating member, and has at least one of a projection or a recess on its surface. One of the elastic bodies is mounted on at least a part of a step portion of an edge formed by the projection or the recess of the first rotating member. In addition, the other elastic body is mounted on at least a part of a step portion of an edge formed by the projection or the recess of the second rotating member.

Further, there is also known an invention related to an electrode producing apparatus that includes a rotary die and an anvil roll (see JP 2017-132019 A). The rotary die includes cutting edges each including a circumferential cutting portion, which protrudes beyond the outer peripheral surface of a die-cut roll of the rotary die in the circumferential direction thereof, and also includes elastic bodies on the outer peripheral surface of the die-cut roll that sandwich the circumferential cutting portions along the axial direction of the die-cut roll. The anvil roll is arranged facing the outer peripheral surface of the die-cut roll. The compressibility of each elastic body in a portion where the gap distance between the die-cut roll and the anvil roll is the shortest is set to greater than or equal to 40% (see claim 1 of JP 2017-132019 A).

### SUMMARY

An amorphous material like the thin amorphous strip disclosed in WO 2017/006868 A has high hardness and low ductility, and thus is difficult to cut. For example, it would be not easy to shear an amorphous material between the edge of the first rotating member and the edge of the second rotating member as in the rotary cutter disclosed in JP 6037690 B. Thus, wear of the rotary cutter, including ablation of its edges, is likely to progress in an early stage.

Meanwhile, when an amorphous material is cut using the rotary die and the anvil roll disclosed in JP 2017-132019 A, there is a possibility that the cutting edges of the rotary die may contact the anvil roll, which can accelerate the wear of the device in an early stage. Meanwhile, if the cutting edges of the rotary die are controlled to not contact the anvil roll, stress that is high enough to fracture the amorphous material with the cutting edges of the rotary die cannot be imparted. Thus, the amorphous material is difficult to cut.

The present disclosure provides rotary dies that can cut amorphous materials while having suppressed wear.

According to an embodiment of the present disclosure, there are provided rotary dies for cutting a target, including an anvil roller configured to rotate while supporting the target; a die cutter including a projecting edge for cutting the target, the die cutter being configured to rotate; a first elastic portion arranged on the outer peripheral surface of the anvil roller, the first elastic portion being adapted to elastically deform upon contacting the rear surface of the target when the target is cut; and a second elastic portion arranged on the outer peripheral surface of the die cutter, the second elastic portion being adapted to elastically deform upon contacting the front surface of the target when the target is cut, in which the hardness of the first elastic portion is higher than that of the second elastic portion.

In the rotary dies of the aforementioned embodiment, the shortest distance between the die cutter and the anvil roller may be longer than the height of the projecting edge and shorter than the sum of the height of the projecting edge and the thickness of the first elastic portion before its elastic deformation.

In the rotary dies of the aforementioned embodiment, the thickness of the second elastic portion before its elastic deformation may be greater than the height of the projecting edge.

In the rotary dies of the aforementioned embodiment, the first elastic portion may contain a non-foam synthetic resin material, and the second elastic portion may contain a foam synthetic resin material.

In the rotary dies of the aforementioned embodiment, the hardness of the first elastic portion may be three times or more that of the second elastic portion.

In the rotary dies of the aforementioned embodiment, the durometer hardness of the first elastic portion may be greater than or equal to 90 A.

In the rotary dies of the aforementioned embodiment, the target may be a thin strip of an amorphous material.

In the rotary dies of the aforementioned embodiment, the first elastic portion may include a first layer arranged on the outer peripheral surface of the anvil roller, and a second layer stacked on the outer periphery of the first layer, and the hardness of the first layer may be higher than that of the second layer.

In the rotary dies of the aforementioned embodiment, the durometer hardness of the second layer may be greater than or equal to 90 A, and the durometer hardness of the first layer may be greater than that of the second layer by 5 A or more.

According to the aforementioned embodiments of the present disclosure, rotary dies can be provided that can cut amorphous materials while having suppressed wear.

### BRIEF DESCRIPTION OF THE DRAWINGS

FIG. 1 is a schematic diagram of a rotary die cutter that uses rotary dies according to Embodiment 1 of the present disclosure.

FIG. 2A is an enlarged schematic cross-sectional diagram of the rotary dies illustrated in FIG. 1.

FIG. 2B is an enlarged cross-sectional diagram illustrating a view in which a target is cut with the rotary dies of FIG. 2A.

FIG. 2C is an enlarged cross-sectional diagram illustrating a view in which a target is cut with the rotary dies of FIG. 2A.

FIG. 3 is a plan view of an exemplary workpiece to be cut out of a target using the rotary dies of FIG. 1.

FIG. 4 is an enlarged schematic cross-sectional diagram of rotary dies according to Embodiment 2 of the present disclosure;

FIG. 5 is a schematic diagram of an experiment for measuring the repulsive force of the first elastic portion of the rotary dies in FIG. 4;

FIG. 6 is a graph illustrating the relationship between the compressibility and the repulsive force of the first elastic portion in FIG. 4;

FIG. 7 is a schematic cross-sectional diagram illustrating the angle of bend of a target due to the rotary dies of FIG. 4; and

FIG. 8 is a graph illustrating the relationship between the difference in hardness between the first layer and the second layer of the first elastic portion in FIG. 4 and the angle of bend of the target.

### DETAILED DESCRIPTION

Hereinafter, an embodiment of rotary dies according to the present disclosure will be described with reference to the drawings.

### Embodiment 1

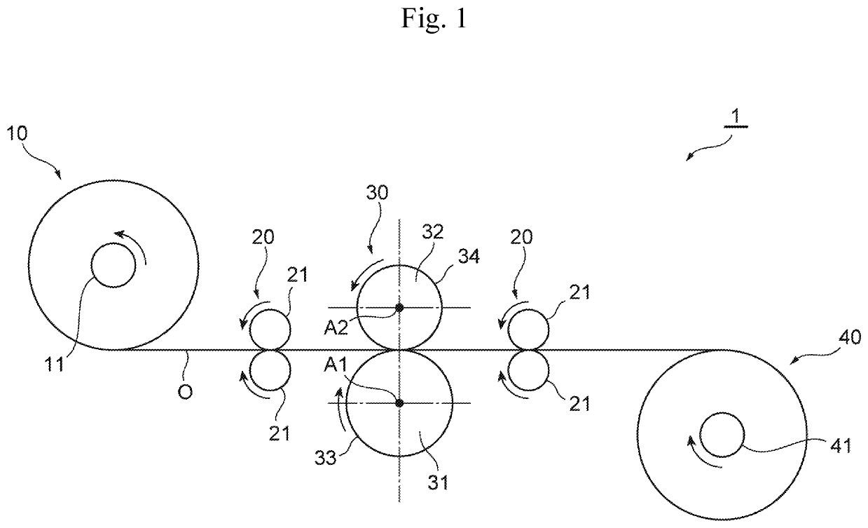

FIG. 1 is a schematic diagram of a rotary die cutter 1 that uses rotary dies according to Embodiment 1 of the present disclosure. The rotary die cutter 1 includes a material supply portion 10, conveying portions 20, rotary dies 30, and a material collecting portion 40, for example.

The material supply portion 10 holds a target O to be cut with the rotary dies 30, and supplies it to the rotary dies 30. The target O is a thin sheet-like metallic material, for example. Specifically, the target O is a thin strip of an amorphous material, that is, a thin amorphous metal strip or a thin amorphous alloy strip, for example. The material supply portion 10 includes a rotating shaft 11 that supports the thin strip of the target O wound in a coil shape, for example. The rotating shaft 11 is configured to be rotatable so as to wind off the thin strip of the target O and supply it to the rotary dies 30, for example.

Each conveying portion 20 includes a pair of conveying rollers 21 that rotate while sandwiching the target O therebetween, for example. The pair of conveying rollers 21 are arranged such that their rotation axes are parallel with each other and the rollers rotate in mutually opposite directions so as to convey the target O while sandwiching it therebetween. The conveying portions 20 are arranged at positions ahead of and behind the rotary dies 30 in the direction of conveying the target O, for example. The speed of conveying the target O with the conveying portions 20 is not particularly limited, but it is in the range of about 200 to 600 [m/min], for example.

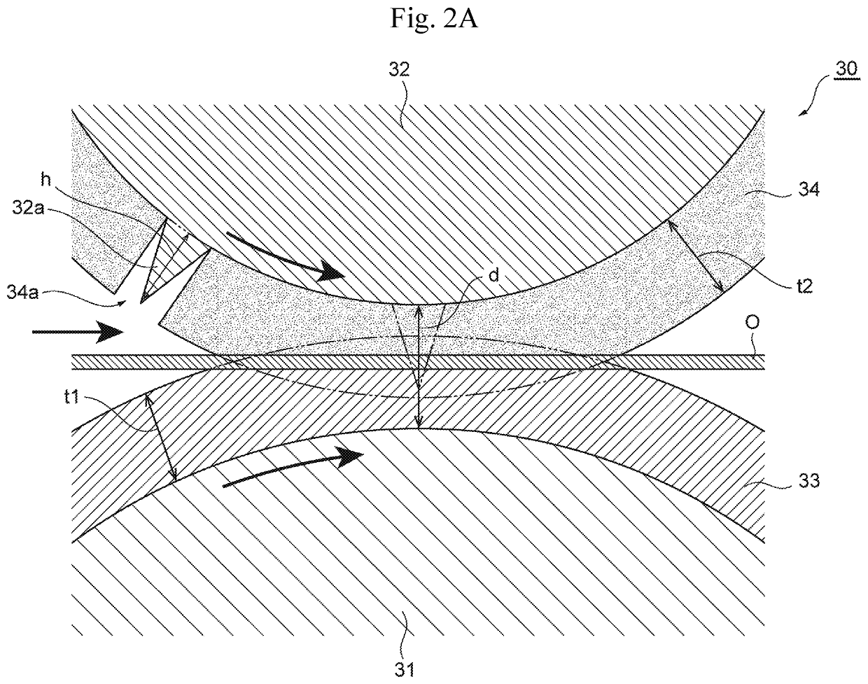

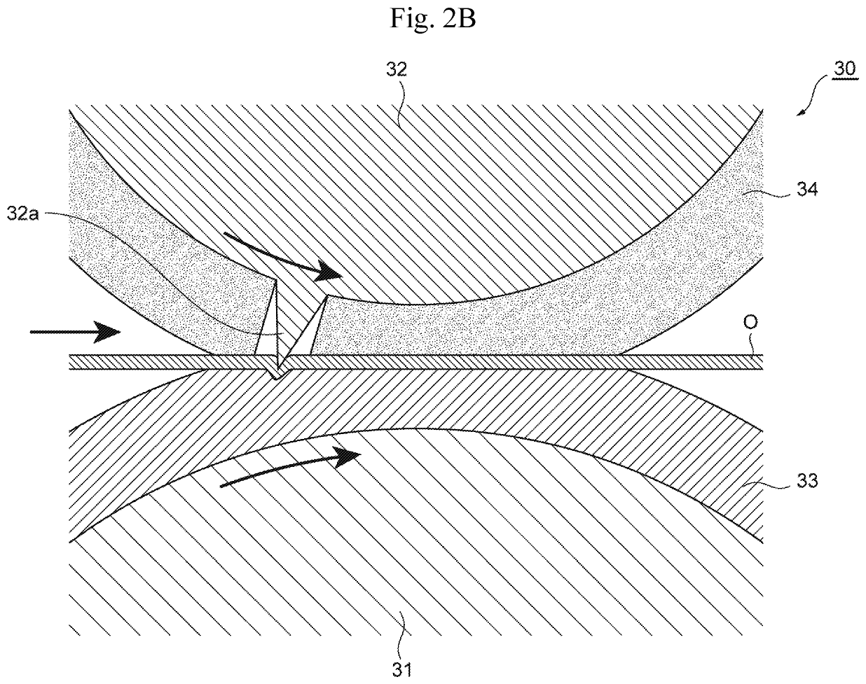

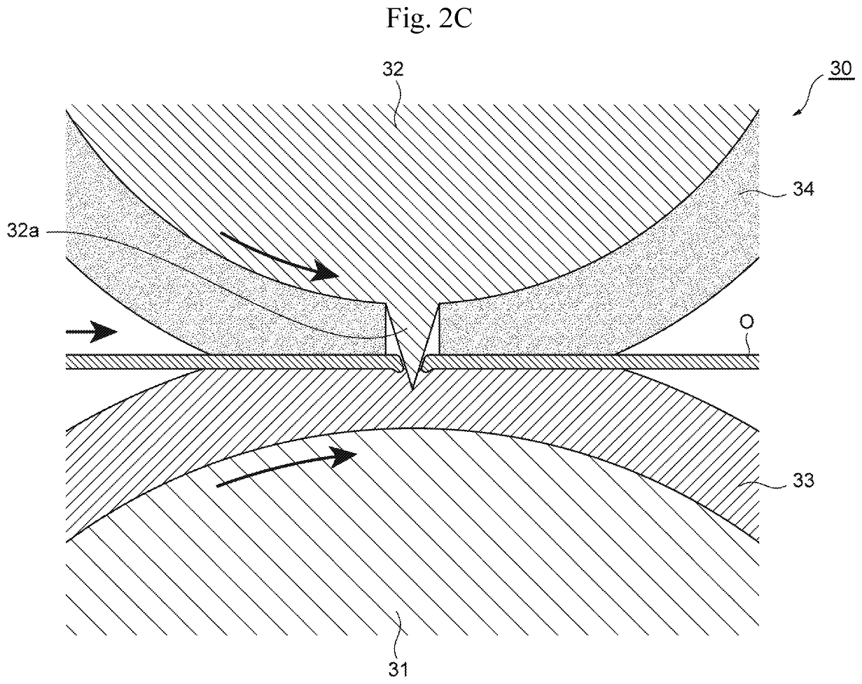

FIG. 2A is an enlarged schematic cross-sectional diagram of the rotary dies 30 illustrated in FIG. 1. FIGS. 2B and 2C are enlarged cross-sectional diagrams each illustrating a view in which the target O is cut with the rotary dies 30 of FIG. 2A. The rotary dies 30 of the present embodiment have the following configuration, though the details will be described later.

The rotary dies 30 are adapted to cut the target O, and include an anvil roller 31, a die cutter 32, a first elastic portion 33, and a second elastic portion 34. The anvil roller 31 rotates while supporting the target O. The die-cutter 32 has a projecting edge 32a for cutting the target O, and rotates. The first elastic portion 33 is arranged on the outer peripheral surface of the anvil roller 31, and elastically deforms upon contacting the rear surface of the target O when the target O is cut. The second elastic portion 34 is arranged on the outer peripheral surface of the die cutter 32, and elastically deforms upon contacting the front surface of the target O when the target O is cut. The hardness of the first elastic portion 33 is higher than that of the second elastic portion 34.

Hereinafter, the configuration of each part of the rotary dies 30 of the present embodiment will be described in detail.

The anvil roller 31 is a cylindrical die configured to be rotatable about the rotation axis A1, and rotates while supporting the target O via the first elastic portion 33 that is arranged on the outer peripheral surface of the anvil roller 31. The outer peripheral surface of the anvil roller 31 is a smooth cylindrical surface without irregularities. However, the outer peripheral surface of the anvil roller 31 may have projections or recesses, for example, so that the first elastic portion 33 can be fixed thereto. As the material of the anvil roller 31, alloy tool steels for cold forging dies (material mark: SKD) or high speed tool steels (material mark: SKH) defined by the Japanese Industrial Standards JIS 4403: 2015, or high speed tool steels (material mark: HAP) produced by Hitachi Metals. Ltd. can be used, for example.

The die cutter 32 is a cylindrical die configured to be rotatable about a rotation axis A2 that is parallel with the rotation axis A1 of the anvil roller 31, and has the projecting edge 32a for cutting the target O on its outer peripheral surface. The die cutter 32 rotates in the direction opposite to the anvil roller 31, thereby cutting the target O while sandwiching it between the first elastic portion 33 arranged on the outer peripheral surface of the anvil roller 31 and the second elastic portion 34 arranged on the outer peripheral surface of the die cutter 32. The same material of the anvil roller 31 can be used as the material of the die cutter 32.

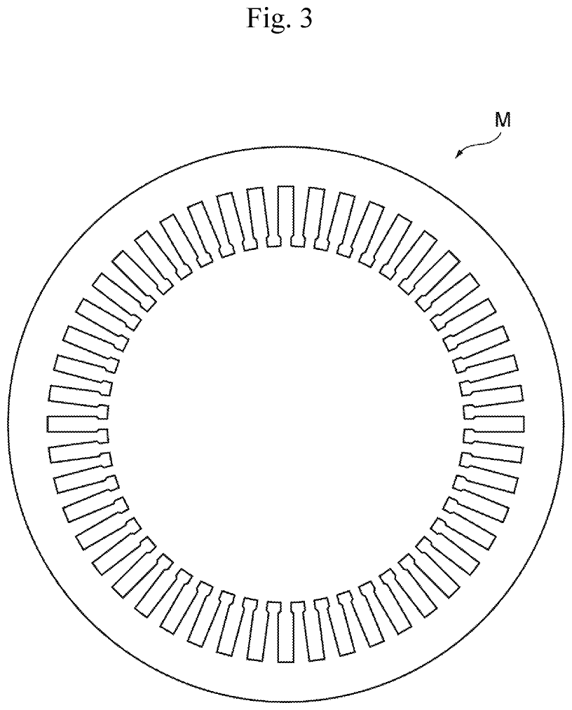

FIG. 3 is a plan view of an exemplary workpiece M to be cut out of the target O using the rotary dies 30. The target O is a thin strip of an amorphous material, for example, and the workpiece M is used for a motor to be mounted on a vehicle, such as a hybrid electric vehicle, an electric vehicle, or a fuel cell electric vehicle. More specifically, the workpiece M is a thin amorphous metal strip or a thin amorphous alloy strip with a thickness about 1/10 that of an electromagnetic steel plate that is used for a typical motor, for example. A plurality of workpieces M is stacked to form a stator of a motor, for example.

The projecting edge 32a has a continuous closed-curve shape extending along the outer peripheral surface of the die cutter 32. When the cylindrical outer peripheral surface of the die cutter 32 is developed into a plane, the planar shape of the projecting edge 32a seen from a direction perpendicular to the outer peripheral surface of the die cutter 32 is roughly the same as the shape of the contour of the workpiece M illustrated in FIG. 3, for example. That is, the projecting edge 32a on the outer peripheral surface of the die cutter 32 has the shape of a closed curve corresponding to the shape of the contour of the workpiece M to be cut out of the target O. The projecting edge 32a may be an engraving edge from the perspective of securing a sufficient height h of the projecting edge 32a protruding beyond the outer peripheral surface of the die cutter 32.

The die cutter 32 includes a plurality of projecting edges 32a in the shape of a closed curve along the circumferential direction of the outer peripheral surface of the die cutter 32, for example. Additionally, the die cutter 32 may include a plurality of projecting edges 32a in the shape of a closed curve on the outer peripheral surface of the die cutter 32 along a direction parallel with the rotation axis A2. In the examples illustrated in FIGS. 1 to 2C, the diameter of the anvil roller 31 is larger than that of the die cutter 32. It should be noted that the diameter of the anvil roller 31 may be less than or equal to that of the die cutter 32.

The first elastic portion 33 is fixed to the outer peripheral surface of the anvil roller 31 using bonding, welding, mechanical joining, or a combination of them, for example, and is arranged on the outer peripheral surface of the anvil roller 31. The first elastic portion 33 is formed of an elastic resin material, for example, and elastically deforms upon contacting the rear surface of the target O when the target O is cut. More specifically, the material of the first elastic portion 33 is a non-foam synthetic resin material, such as an urethane rubber sheet, for example.

The second elastic portion 34 is fixed to the outer peripheral surface of the die cutter 32 using bonding, welding, mechanical joining, or a combination of them, for example, and is arranged on the outer peripheral surface of the die cutter 32. The second elastic portion 34 is formed of an elastic resin material, for example, and elastically deforms upon contacting the front surface of the target O when the target O is cut. More specifically, the material of the second elastic portion 34 is a foam synthetic resin material, such as an urethane foam sheet or an urethane sponge sheet.

The thickness t2 of the second elastic portion 34 is greater than the height h of the projecting edge 32a of the die cutter 32, for example. More specifically, the thickness t2 of the second elastic portion 34 before it elastically deforms is greater than the height h of the projecting edge 32a. Accordingly, before the second elastic portion 34 elastically deforms, the outer surface of the second elastic portion 34 is located on the outer side of the distal end of the projecting edge 32a in the radial direction of the die cutter 32. Herein, the thickness t2 of the second elastic portion 34 is the dimension of the second elastic portion 34 measured in the radial direction of the die cutter 32. In addition, the height h of the projecting edge 32a is the dimension of the projecting edge 32a measured in the radial direction of the die cutter 32 in the range of from the proximal end of the projecting edge 32a coupled to the outer peripheral surface of the die cutter 32 to the distal end of the projecting edge 32a.

The second elastic portion 34 has a groove 34a for exposing the projecting edge 32a on the outer peripheral surface of the die cutter 32, for example. That is, the second elastic portion 34 is arranged on the entire outer peripheral surface of the die cutter 32 excluding the portion where the projecting edge 32a is provided. That is, the second elastic portion 34 is arranged not only in a region on the outer side of the projecting edge 32a in the shape of a closed curve corresponding to the shape of the contour of the workpiece M illustrated in FIG. 3 but also in a region on the inner side of the projecting edge 32a, on the outer peripheral surface of the die cutter 32, for example.

As described above, the hardness of the first elastic portion 33 is higher than that of the second elastic portion 34. In some embodiments, the hardness of the first elastic portion 33 is three times or more that of the second elastic portion 34, for example, as described below. Herein, the hardness of each of the first elastic portion 33 and the second elastic portion 34 can be measured using a method compliant with the Japanese Industrial Standards JIS K 6253-3: 2012 or JIS K 7312: 1996. That is, the hardness of each of the first elastic portion 33 and the second elastic portion 34 is type A (Shore A) of durometer hardness, for example. In some embodiments, the durometer hardness of the first elastic portion 33 is higher than or equal to 90 A, for example, as described below.

The shortest distance d between the die cutter 32 and the anvil roller 31 is the distance between the outer peripheral surface of the die cutter 32 and the outer peripheral surface of the anvil roller 31 along straight lines that are orthogonal to the rotation axis A1 of the anvil roller 31 and the rotation axis A2 of the die cutter 32. The shortest distance d is longer than the height h of the projecting edge 32a and is shorter than the sum of the height h of the projecting edge 32a and the thickness t1 of the first elastic portion 33 before it elastically deforms. That is, inequality: h<d<(h+t1) is satisfied.

The material collecting portion 40 collects the portion of the target O that remains after the workpiece M has been cut out of the target O by the rotary dies 30, for example. The material collecting portion 40 includes, for example, a rotating shaft 41 for collecting the remaining portion of the target O and supporting it. The rotating shaft 41 is configured to be rotatable so as to wind up the remaining portion of the target O. It should be noted that the configuration of the material collecting portion 40 is not limited to the one including the rotating shaft 41. For example, the material collecting portion 40 may be configured to collect the remaining portion of the target O by cutting it.

Hereinafter, the function of the rotary dies 30 of the present embodiment will be described.

The rotary dies 30 of the present embodiment are used as the dies of the rotary die cutter 1 such as the one illustrated in FIG. 1, for example, as described above. The rotary dies 30 are adapted to cut the workpiece M such as the one illustrated in FIG. 3 out of the target O that is a thin strip of an amorphous material supplied from the material supply portion 10 and the conveying portion 20, for example. The workpiece M that has been cut out is collected and used as a member for an in-vehicle motor, for example. Meanwhile, the portion of the target O that remains after the workpiece M has been cut out is collected by the material collecting portion 40.

Herein, the rotary dies 30 of the present embodiment are adapted to cut the target O as described above, and have the following configuration: the anvil roller 31 that rotates while supporting the target O, the die cutter 32 that has the projecting edge 32a for cutting the target O and rotates, the first elastic portion 33 that is arranged on the outer peripheral surface of the anvil roller 31 and undergoes elastic deformation upon contacting the rear surface of the target O when the target O is cut, and the second elastic portion 34 that is arranged on the outer peripheral surface of the die cutter 32 and undergoes elastic deformation upon contacting the front surface of the target O when the target O is cut. The hardness of the first elastic portion 33 is higher than that of the second elastic portion 34.

With such a configuration, as illustrated in FIG. 2A, the second elastic portion 34 in contact with the front surface of the target O can more easily elastically deform than can the first elastic portion 33 so that the target O can be held between the first elastic portion 33 and the second elastic portion 34. In addition, since the amount of elastic deformation of the first elastic portion 33 in contact with the rear surface of the target O can be made less than that of the second elastic portion 34, the target O can be stably held by the first elastic portion 33.

Further, as illustrated in FIG. 2B, when the anvil roller 31 and the die cutter 32 rotate, the projecting edge 32a provided on the outer peripheral surface of the die cutter 32 bites into the front surface of the target O. At this time, the first elastic portion 33 elastically deforms and thus permits deformation of the target O in the direction in which the target O is to be cut. In addition, at positions ahead of and behind the projecting edge 32a in the direction of conveying the target O, the front surface of the target O is pressed by the second elastic portion 34 that has elastically deformed more than has the first elastic portion 33, and thus, the rear surface of the target O is supported by the first elastic portion 33 that has elastically deformed less than has the second elastic portion 34.

Accordingly, the target O can be held between the first elastic portion 33 and the second elastic portion 34 at positions ahead of and behind the projecting edge 32a, and thus, deformation and positional deviations of the target O can be suppressed. Therefore, as the projecting edge 32a bites into the front surface of the target O, a tensile force acts on the target O at positions ahead of and behind the projecting edge 32a in the direction of conveying the target O between the first elastic portion 33 and the second elastic portion 34. Further, rotating the anvil roller 31 and the die cutter 32 will cause the target O to fracture as illustrated in FIG. 2C, starting from the portion bit by the projecting edge 32a.

It should be noted that in the example illustrated in FIG. 2C, the distal end of the projecting edge 32a bites into the first elastic portion 33. However, the distal end of the projecting edge 32a need not bite into the first elastic portion 33. As described above, a tensile force acts on the target O at positions ahead of and behind the projecting edge 32a. Therefore, as long as the distal end of the projecting edge 32a is allowed to bite into the target O, the target O can be fractured starting from the portion bit by the projecting edge 32a even if the distal end of the projecting edge 32a does not bite into the first elastic portion 33.

As described above, the rotary dies 30 of the present embodiment fracture the target O by allowing a tensile force to act on the target O and thus promoting growth of a crack, which has been generated in the target O starting from the portion bit by the projecting edge 32a, without using shear of the target O which would occur between a die and a punch if stamping is performed using die pressing. Accordingly, it is possible to not only suppress wear of the projecting edge 32a but also form the workpiece M with high precision while reducing burrs and warps of the workpiece M.

Further, the target O to be cut with the rotary dies 30 of the present embodiment is a thin strip of an amorphous material, for example. An amorphous material has higher hardness than those of conventional steel materials, such as electromagnetic steel plates. Therefore, if stamping is performed using die pressing so as to shear the target O of an amorphous material between edges of a die and a punch and thus cut the workpiece M with a contour shape illustrated in FIG. 3 out of the target O at a time, a load acting on the die becomes large, which in turn can accelerate the wear of the die in an early stage and thus can shorten the lifetime of the die.

Meanwhile, when the workpiece M is cut out of the target O using the rotary dies 30 of the present embodiment, the cutting of the workpiece M with the contour shape sequentially progresses with the passage of time as illustrated in FIGS. 2A to 2C. Therefore, according to the rotary dies 30 of the present embodiment, a load that would act while the target O is cut can be reduced in comparison with when the workpiece M with the contour shape is sheared between the edges of a die and a punch at a time through stamping using die pressing. Accordingly, wear of the rotary dies 30 can be suppressed and the lifetime of the rotary dies 30 can be prolonged.

Further, the thickness of a thin strip of an amorphous material used for a motor is about 1/10 that of an electromagnetic steel plate that has been conventionally used for motors. Therefore, for example, when the workpiece M cut out of the target O that is a thin strip of an amorphous material is used for a motor, instead of a conventional electromagnetic steel plate, the time needed to cut the workpiece M out of the target O should be significantly shortened in comparison with when the conventional electromagnetic steel plate is used.

Herein, the rotary dies 30 of the present embodiment can, with the anvil roller 31 and the die cutter 32 rotated continuously at a high speed, supply the target O continuously at a high speed and thus can machine the target O into the workpiece M continuously at a high speed. Therefore, the time needed to cut the workpiece M out of the target O can be significantly reduced in comparison with when stamping is performed using die pressing, and thus, the productivity of workpieces M can be improved. Accordingly, the workpieces M of an amorphous material can be used for a motor, and loss of the motor as well as power consumption can be reduced.

In addition, in the rotary dies 30 of the present embodiment, the shortest distance d between the die cutter 32 and the anvil roller 31 is longer than the height h of the projecting edge 32a and is shorter than the sum of the height h of the projecting edge 32a and the thickness t1 of the first elastic portion 33 before it elastically deforms.

According to such a configuration, after the projecting edge 32a is caused to bite into the front surface of the target O as illustrated in FIGS. 2A and 2B, the first elastic portion 33 can further elastically deform toward the outer peripheral surface of the anvil roller 31. Specifically, for example, the target O can be fractured as illustrated in FIG. 2C in a state in which the target O is pressed against the first elastic portion 33 toward the outer peripheral surface of the anvil roller 31 up to about half the thickness t1 of the first elastic portion 33 before it elastically deforms. Accordingly, a sufficient tensile force can act on the target O. and the target O can be more reliably fractured starting from the portion bit by the projecting edge 32a.

In addition, in the rotary dies 30 of the present embodiment, the thickness t2 of the second elastic portion 34 before it elastically deforms is greater than the height h of the projecting edge 32a of the die cutter 32.

According to such a configuration, the second elastic portion 34 can contact the front surface of the target O before the projecting edge 32a bites into the front surface of the target O, and thus, the second elastic portion 34 can elastically deform toward the radially inner side of the die cutter 32. Accordingly, an elastic force is allowed to act on the front surface of the target O toward the radially outer side of the die cutter 32 by the second elastic portion 34, and the target O can be pressed against the first elastic portion 33. Consequently, when the projecting edge 32a is caused to bite into the front surface of the target O, the target O can be securely held between the first elastic portion 33 and the second elastic portion 34 at positions ahead of and behind the projecting edge 32a in the direction of conveying the target O, whereby positional deviations of the target O can be suppressed, and a tensile force can act on the target O.

In the rotary dies 30 of the present embodiment, the first elastic portion 33 is made of a non-foam synthetic resin material, and the second elastic portion 34 is made of a foam synthetic resin material.

According to such a configuration, the second elastic portion 34 can elastically deform more easily than can the first elastic portion 33, and the hardness of the first elastic portion 33 can be made higher than that of the second elastic portion 34. In addition, the difference in hardness between the first elastic portion 33 and the second elastic portion 34 can be increased such that the hardness of the first elastic portion 33 can be made three times or more that of the second elastic portion 34.

In addition, in the rotary dies 30 of the present embodiment, the hardness of the first elastic portion 33 can be made three times or more that of the second elastic portion 34.

According to such a configuration, the first elastic portion 33 that receives an elastic force acting toward the radially inner side of the anvil roller 31 from the second elastic portion 34 via the target O is allowed to elastically deform less easily. Accordingly, the rear surface of the target O can be supported by the hard first elastic portion 33 so that deformation and positional deviations of the target O can be suppressed. Further, as a sufficiently high elastic force can be provided to the front surface of the target O by the soft second elastic portion 34, deformation and positional deviations of the target O can be suppressed.

Further, in the rotary dies 30 of the present embodiment, the durometer hardness of the first elastic portion 33 is greater than or equal to 90 A.

According to such a configuration, the rear surface of the target O can be supported by the first elastic portion 33 with sufficient hardness so that deformation and positional deviations of the target O can be more reliably suppressed. Further, as the first elastic portion 33 has sufficient hardness, the shock resistance, wear resistance, and durability of the first elastic portion 33 can be improved.

As described above, according to the present embodiment, the rotary dies 30 that can cut amorphous materials while having suppressed wear can be provided.

### Embodiment 2

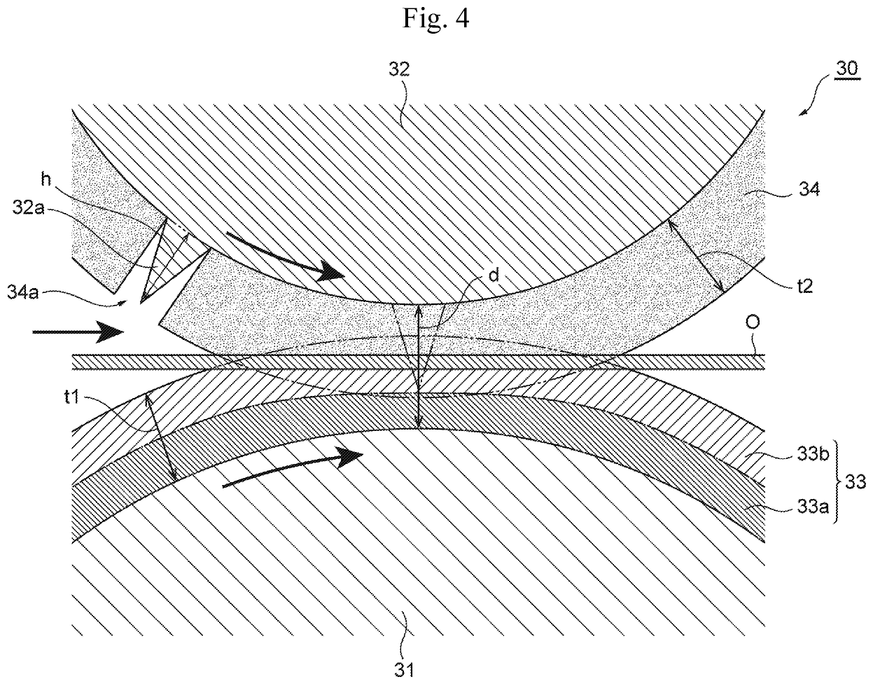

Next, Embodiment 2 of rotary dies according to the present disclosure will be described with reference to FIGS. 4 to 8 with the aid of FIGS. 1, 2B, and 2C. FIG. 4 is an enlarged schematic cross-sectional diagram of rotary dies 30 according to the present embodiment.

The rotary dies 30 of the present embodiment differs from the rotary dies 30 of Embodiment 1 described above in the configuration of the first elastic portion 33 arranged on the outer peripheral surface of the anvil roller 31. The other configurations of the rotary dies 30 of the present embodiment are similar to those of the rotary dies 30 of Embodiment 1 described above. Therefore, similar portions are denoted by identical reference numerals and the descriptions thereof will be omitted.

As illustrated in FIG. 4, the first elastic portion 33 includes a first layer 33a arranged on the outer peripheral surface of the anvil roller 31, and a second layer 33b stacked on the outer periphery of the first layer 33a. The hardness of the first layer 33a is higher than that of the second layer 33b. More specifically, for example, the durometer hardness of the second layer 33b is greater than or equal to 90 A, and the durometer hardness of the first layer 33a is greater than that of the second layer 33b by 5 A or more. Each of the first layer 33a and the second layer 33b is made of a non-foam synthetic resin material, such as a urethane rubber sheet, for example.

The thickness of each of the first layer 33a and the second layer 33b is not particularly limited as long it can fracture the target O appropriately. The thickness of each of the first layer 33a and the second layer 33b can be set to about four to five times that of the target O. More specifically, if the thickness of the target O is about 20 to 30 μm, the thickness of each of the first layer 33a and the second layer 33b can be set to about 80 to 150 μm, for example. The ratio of the thickness of the first layer 33a to that of the second layer 33b can be set to about 1:1 to 2:1, for example. That is, the thickness of the first layer 33a is greater than or equal to that of the second layer 33b and less than or equal to double the thickness of the second layer 33b, for example.

Hereinafter, the function of the rotary dies 30 of the present embodiment will be described.

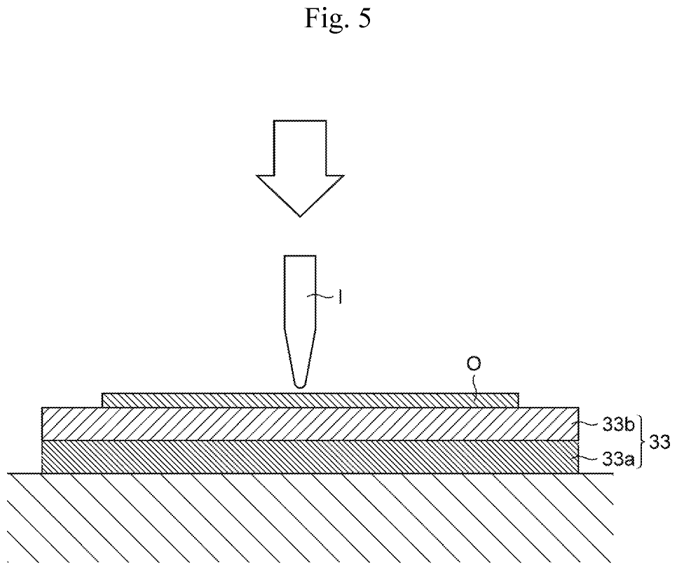

FIG. 5 is a schematic diagram of an experiment for measuring the repulsive force of the first elastic portion 33 with the two-layer structure of the rotary dies 30 the present embodiment. The first elastic portion 33 with the two-layer structure including the first layer 33a and the second layer 33b was arranged on a flat base, and the target O was arranged thereon. Then, the target O was pressed against the first elastic portion 33 while a load was applied to an indenter I with a shape similar to that of the projecting edge 32a so that the compressibility and the repulsive force of the first elastic portion 33 were measured. Similar experiments were conducted on the first elastic portion 33 with a single layer of the rotary dies 30 of Embodiment 1.

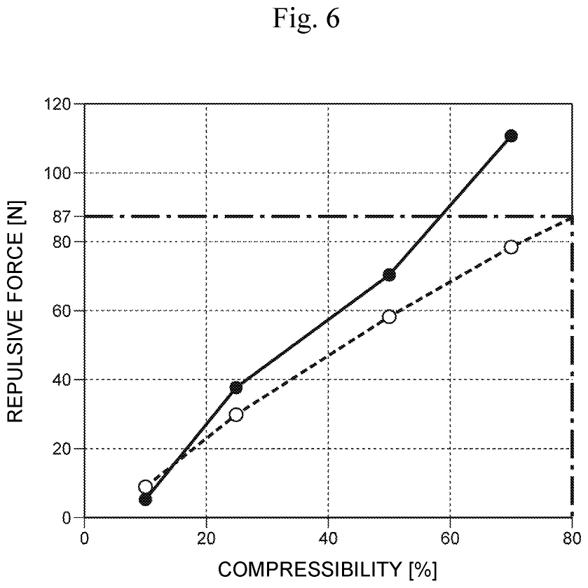

FIG. 6 is a graph illustrating the relationship between the compressibility and the repulsive force of the first elastic portion 33 obtained in the experiment illustrated in FIG. 5. In the graph of FIG. 6, the abscissa axis represents the compressibility of the first elastic portion 33, and the ordinate axis represents the measured repulsive force of the first elastic portion 33. In addition, the solid line represents the results of the first elastic portion 33 with the two-layer structure of the present embodiment including the first layer 33a and the second layer 33b, while the dashed line represents the results of the first elastic portion 33 with a single layer similar to that of Embodiment 1.

As illustrated in FIG. 4, with the rotary dies 30 of the present embodiment, the target O is sandwiched between the second elastic portion 34 arranged on the outer peripheral surface of the die cutter 32 and the first elastic portion 33 arranged on the outer peripheral surface of the anvil roller 31, and the target O is fractured while being conveyed as illustrated in FIGS. 2B and 2C. To fracture the target O appropriately, the compressibility of the first elastic portion 33 should be set to less than or equal to 80%, for example. In addition, to fracture the target O appropriately, the repulsive force of the first elastic portion 33 may be higher.

As indicated by the dashed line in the graph of FIG. 6, the single-layer first elastic portion 33 has a repulsive force of less than or equal to about 87 N at a compressibility in the range of less than or equal to 80%. In contrast, as indicated by the solid line in the graph of FIG. 6, the first elastic portion 33 with the two-layer structure of the present embodiment generates, at a compressibility in the range of greater than or equal to 20%, a repulsive force greater than that of the single-layer first elastic portion 33 indicated by the dashed line at the same compressibility of the single-layer first elastic portion 33.

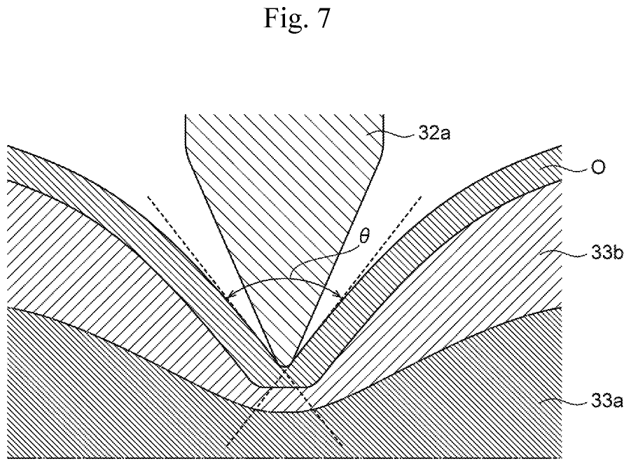

FIG. 7 is a schematic cross-sectional diagram illustrating the relationship between the repulsive force of the first elastic portion 33 and the angle θ of bend of the target O. As described above, the first elastic portion 33 of the rotary dies 30 of the present embodiment includes the first layer 33a arranged on the outer peripheral surface of the anvil roller 31, and the second layer 33b stacked on the outer periphery of the first layer 33a. In addition, the hardness of the first layer 33a is higher than that of the second layer 33b.

According to such a configuration, as illustrated in FIG. 6, in comparison with when the first elastic portion 33 does not include the first layer 33a or the second layer 33b, the repulsive force of the first elastic portion 33 that supports the target O is increased and the angle θ of bend of the target O when the projecting edge 32a bites into the target O becomes smaller. Accordingly, greater bending stress can be generated in the target O and cracks can be more easily generated in the target O so that wear of the projecting edge 32a as well as generation of burrs of the workpiece M can be suppressed, and thus, a thin, hard amorphous material can be fractured with high precision.

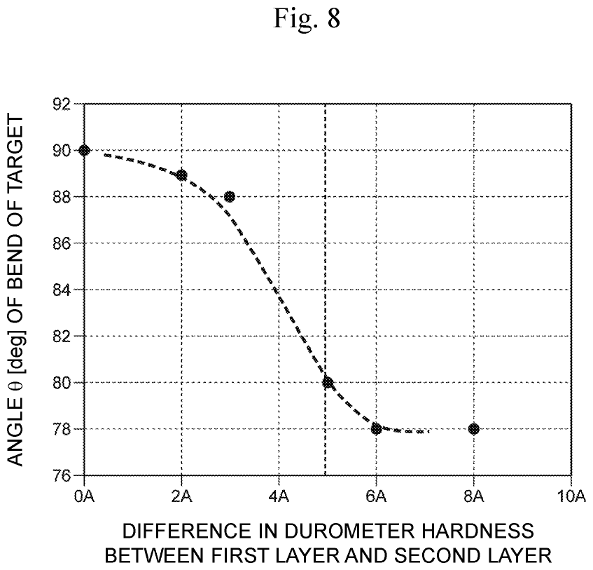

FIG. 8 is a graph illustrating the relationship between the difference in durometer hardness between the first layer 33a and the second layer 33b of the first elastic portion 33 and the angle θ of bend of the target O. In the rotary dies 30 of the present embodiment, the durometer hardness of the second layer 33b of the first elastic portion 33 is greater than or equal to 90 A for example, and the durometer hardness of the first layer 33a of the first elastic portion 33 is greater than that of the second layer 33b by 5 A or more, for example.

According to such a configuration, as illustrated in FIG. 8, the angle θ of bend of the target O when the projecting edge 32a bites into the target O can be made acute, for example, less than or equal to 80 degrees. Accordingly, sufficient tensile stress is allowed to act on the portion of the target O into which the projecting edge 32a bites, and thus, the target O can be more easily fractured with higher precision. Therefore, wear of the projecting edge 32a as well as generation of burrs of the workpiece M can be suppressed, and thus, a thin, hard amorphous material with a thickness of about 20 to 30 μm and with a Vickers hardness of about 900 HV, for example, can be fractured with high precision.

Although embodiments of the rotary dies according to the present disclosure have been described in detail with reference to the drawings, specific configurations of the present disclosure are not limited thereto, and any design changes that are within the spirit and scope of the present disclosure are included in the present disclosure.

### DESCRIPTION OF SYMBOLS

30 Rotary dies
31 Anvil roller
32 Die cutter
32a Projecting edge
33 First elastic portion
33a First layer
33b Second layer
34 Second elastic portion
d Shortest distance
h Height of projecting edge
O Target
t1 Thickness of first elastic portion
t2 Thickness of second elastic portion

What is claimed is:

1. Rotary dies for cutting a target, comprising:
an anvil roller configured to rotate while supporting the target;
a die cutter including a projecting edge for cutting the target, the die cutter being configured to rotate;
a first elastic portion arranged on an outer peripheral surface of the anvil roller, the first elastic portion being adapted to elastically deform upon contacting a rear surface of the target when the target is cut; and
a second elastic portion arranged on an outer peripheral surface of the die cutter, the second elastic portion being adapted to elastically deform upon contacting a front surface of the target when the target is cut,
wherein:
a hardness of the first elastic portion is higher than that of the second elastic portion.

2. The rotary dies according to claim 1, wherein a shortest distance between the die cutter and the anvil roller is longer than a height of the projecting edge and is shorter than a sum of the height of the projecting edge and a thickness of the first elastic portion before its elastic deformation.

3. The rotary dies according to claim 1, wherein a thickness of the second elastic portion before its elastic deformation is greater than the height of the projecting edge.

4. The rotary dies according to claim 1,
wherein:
the first elastic portion contains a non-foam synthetic resin material, and
the second elastic portion contains a foam synthetic resin material.

5. The rotary dies according to claim 1, wherein a hardness of the first elastic portion is three times or more that of the second elastic portion.

6. The rotary dies according to claim 1, wherein a durometer hardness of the first elastic portion is greater than or equal to 90 A.

7. The rotary dies according to claim 1, wherein the target is a thin strip of an amorphous material.

8. The rotary dies according to claim 1,
wherein:
the first elastic portion includes a first layer arranged on the outer peripheral surface of the anvil roller, and a second layer stacked on an outer periphery of the first layer, and
a hardness of the first layer is higher than that of the second layer.

9. The rotary dies according to claim 8,
wherein:
a durometer hardness of the second layer is greater than or equal to 90 A, and
a durometer hardness of the first layer is greater than that of the second layer by 5 A or more.
